(19) United States
(12) Patent Application Publication
(10) Pub. No.: US 2024/0170849 A1
(43) Pub. Date: May 23, 2024

(54) MULTI-BAND METASURFACE ANTENNA

(71) Applicants: California Institute of Technology, Pasadena, CA (US); The University of North Carolina at Charlotte, Charlotte, NC (US)

(72) Inventors: Nacer E. CHAHAT, Altadena, CA (US); Goutam CHATTOPADHYAY, Pasadena, CA (US); Mario Junior MENCAGLI, Charlotte, NC (US); Kristy HECHT, Charlotte, NC (US)

(21) Appl. No.: 18/515,035

(22) Filed: Nov. 20, 2023

Related U.S. Application Data
(60) Provisional application No. 63/426,829, filed on Nov. 21, 2022.

(51) Int. Cl. H01Q 9/04; H01Q 5/40

(52) U.S. Cl. CPC H01Q 9/0442; H01Q 5/40; H01Q 9/045

(57) ABSTRACT

A multi-band metasurface antenna is described. The antenna includes a plurality of stacked metasurface layers for operation according to a respective plurality of separate and distant frequencies. Each metasurface layer presents a high impedance at frequencies that are different from the respective frequency. The metasurface layers are stacked according to a decreasing order of the respective frequencies, with the highest frequency closer to a bottom ground layer of the stack. The metasurface layers are separated by dielectric layers of equal permittivity. According to one aspect, the antenna includes two metasurface layers for respective operation according to a Ka-band and a W-band. According to another aspect, the antenna includes an integrated feed structure that includes respective inner conductors vertically arranged through the dielectric layers to make contact with respective feeder extensions that are in contact with the respective metasurface layers.

### CROSS REFERENCE TO RELATED APPLICATIONS

The present application claims priority to U.S. Provisional Application No. 63/426,829 entitled “Orthogonally Selected Multi-Band Metasurface Antenna For Next Generation Telecommunication And Remote Sensing Applications”, filed on Nov. 21, 2022, the content of which is incorporated herein by reference in its entirety.

### STATEMENT OF GOVERNMENT GRANT

This invention was made with government support under Grant No. 80NM00018D0004 awarded by NASA (JPL). The government has certain rights in the invention.

### TECHNICAL FIELD

The present disclosure relates to antennas. More particularly, it relates to a multi-band flat metasurface antenna that includes respective metasurface layers for controlling radiations at frequencies of the respective bands.

### BACKGROUND

The demand for multifrequency medium-to-high gain antennas is rapidly increasing in many application areas, including earth and climate science, remote sensing, satellite communications and 5G. These antennas, by exploiting the same radiating aperture at different frequency bands, offer the possibility to increase the channel capacity, improve the isolation between the transmitted and received signals, and provide multiple functionalities.

Reflectarray and transmitarray antennas have been largely explored as radiators operating in multiple frequency bands. Among other advantages, these antenna solutions are characterized by low cost, low weight, and ease of fabrication. However, they usually require an external feed, which makes them less appealing for applications with severe space constraints, such as, for example, small platform airborne radar systems, including for example, CMOS radar systems that may be integrated with UAVs, Cubesats™ or Smallsats™. Furthermore, such antenna solutions may allow operation according to frequency bands that are relatively close to one another (e.g., relatively small separation between the bands). In other words, they may not allow support of largely separated frequency bands, such as, for example, Ka-band (e.g., 27-40 GHz) and W-band (e.g., 75-110 GHz).

It follows that a motivation of the teachings according to the present disclosure is a multifrequency antenna solution that may include, in addition to the above-described benefits of reflectarrays/transmitarrays, an integrated feed and support of largely separated frequency bands.

### SUMMARY

According to one embodiment the present disclosure, a dual-band metasurface antenna is presented, comprising: a ground layer; a dielectric layer overlying the ground layer; a first metasurface layer configured for operation at a first frequency, the first metasurface layer overlying the dielectric layer; and a second metasurface layer configured for operation at a second frequency that is higher than the first frequency, the second metasurface layer embedded within the dielectric layer, wherein at the first frequency of operation, the second metasurface layer presents a high impedance, and at the second frequency of operation, the first metasurface layer presents a high impedance.

According to a second embodiment of the present disclosure, a multi-band metasurface antenna is presented, comprising: a ground layer; a dielectric layer overlying the ground layer; a top metasurface layer overlying the dielectric layer; and a plurality of embedded metasurface layers embedded within the dielectric layer, wherein each metasurface layer of the top metasurface layer and the plurality of embedded metasurface layers is configured for operation at a respective frequency of a plurality of different frequencies, the respective frequency of a metasurface layer of the plurality of embedded metasurface layers arranged at a respective distance from the ground layer is higher than the respective frequency of any metasurface layer of the top metasurface layer or the plurality of embedded metasurface layers arranged at a farther respective distance from the ground layer, and a respective impedance of a metasurface layer of the top metasurface layer or the plurality of embedded metasurface layers at a frequency of the plurality of different frequencies that is different from the respective frequency is a high impedance.

According to a third embodiment of the present disclosure, a method for realizing a dual-band metasurface antenna is presented, the method comprising: realizing a first metasurface for operation at a first frequency by forming a first sequence of a plurality of first subwavelength unit cells having a first periodic pattern provided by modulation of a dimension of respective first metallic patches, thereby providing a local periodicity of a first surface impedance of the first metasurface at the first frequency; and realizing a second metasurface for operation at a second frequency by forming a second sequence of a plurality of second subwavelength unit cells having a second periodic pattern provided by modulation of a dimension of respective second metallic patches, thereby providing a local periodicity of a second surface impedance of the second metasurface at the second frequency, wherein the realizing of the first metasurface further includes: based on the local periodicity of the first surface impedance, deriving an equivalent first reactance of the first surface impedance from a transmission line model, the equivalent first reactance provided by a first frequency response that includes a pole at zero frequency followed by alternating zeros and poles for increasing frequencies; and making or verifying that the equivalent first reactance at the second frequency is near to, or at, a pole of the first frequency response, thereby making the first surface impedance high at the second frequency.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a simplified cross-sectional view of a prior art single layer metasurface antenna.

FIG. 2 shows features of a metasurface layer used for generation of a surface impedance profile according to an embodiment of the present disclosure.

FIG. 3A shows a simplified cross-sectional view of a multi-layer metasurface antenna according to an embodiment of the present disclosure for operation according to two distant frequency bands.

FIG. 3B shows simplified equivalent cross-sectional views of the multi-layer metasurface antenna of FIG. 3A during operation according to each of the two distant frequency bands.

FIG. 4 shows respective features of two metasurface layers used for generation of respective surface impedance profiles according to an embodiment of the present disclosure.

FIG. 5 shows graphs representative of design for two mutually transparent metasurface layers according to an embodiment of the present disclosure.

FIG. 6 shows a feed structure integrated within the multi-layer metasurface antenna of FIG. 3A.

FIG. 7 shows a top view of a multi-layer metasurface antenna according to an exemplary embodiment of the present disclosure.

Like reference numbers and designations in the various drawings indicate like elements.

### DETAILED DESCRIPTION

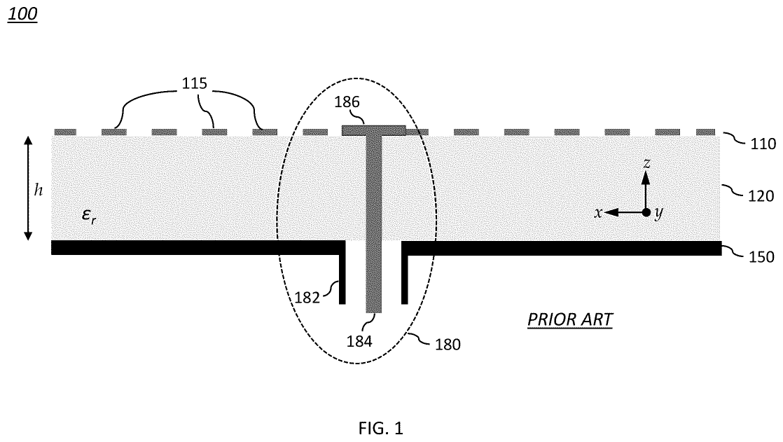

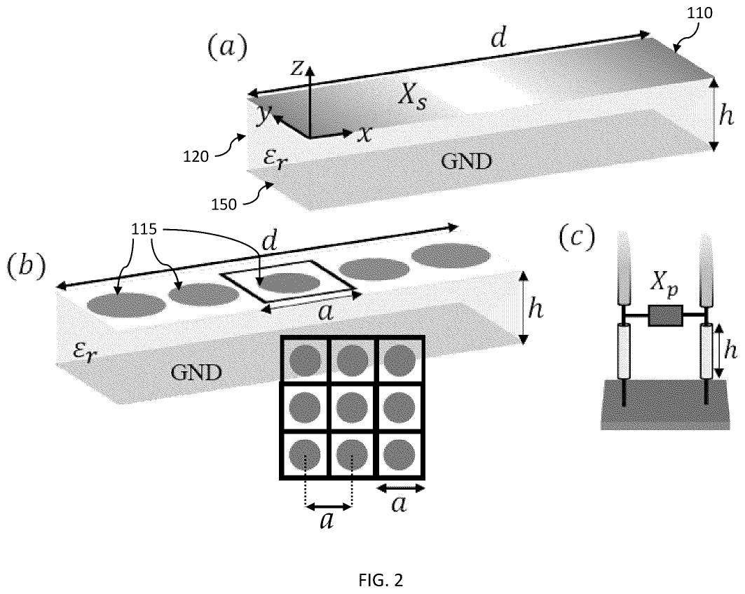

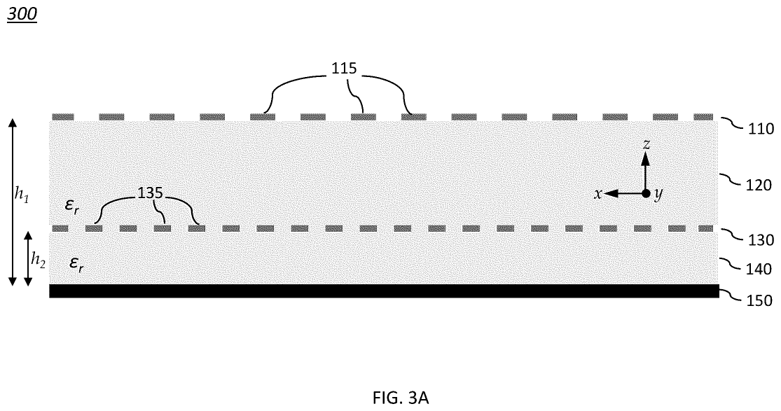

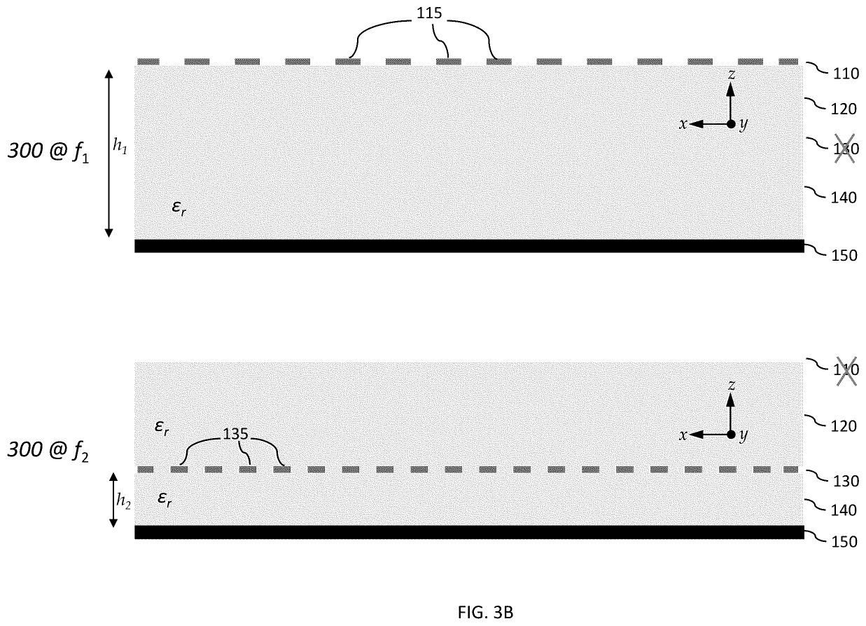

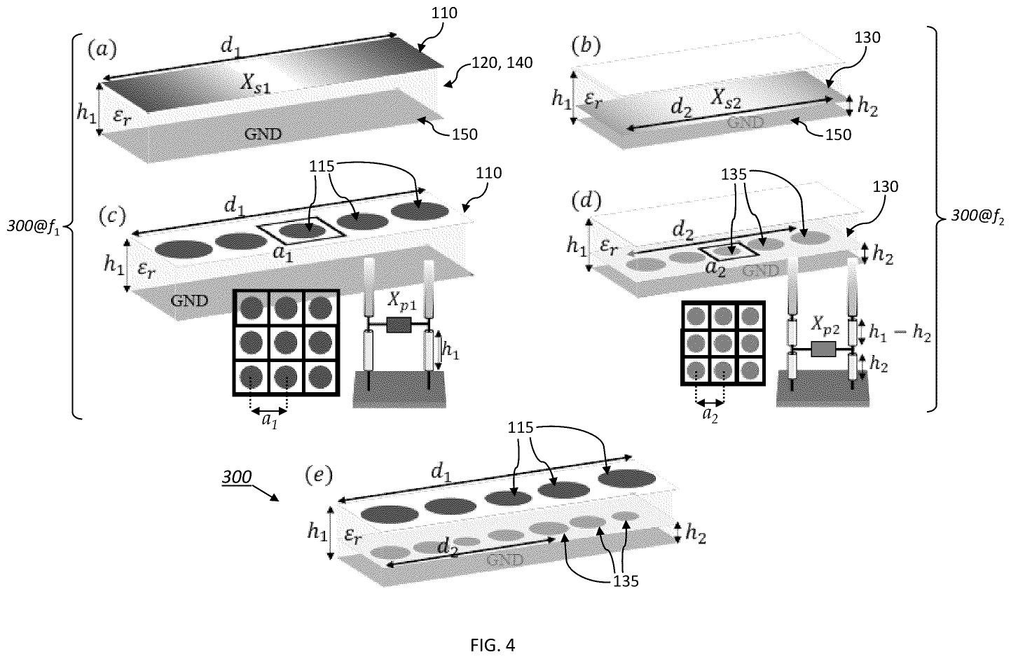

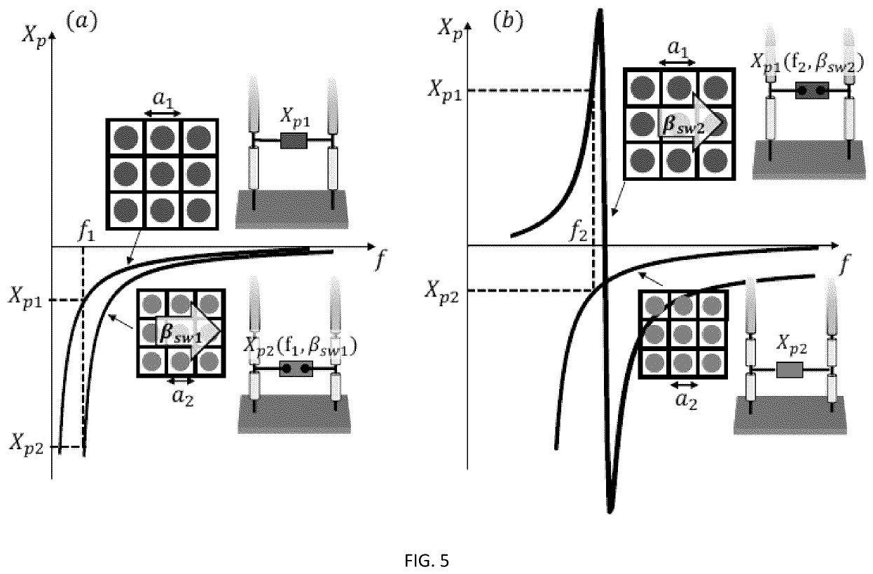

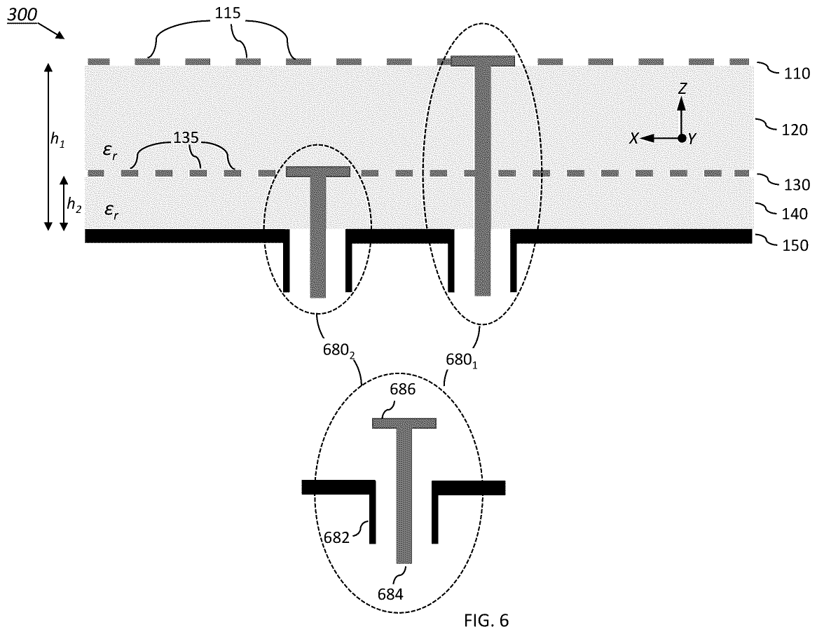

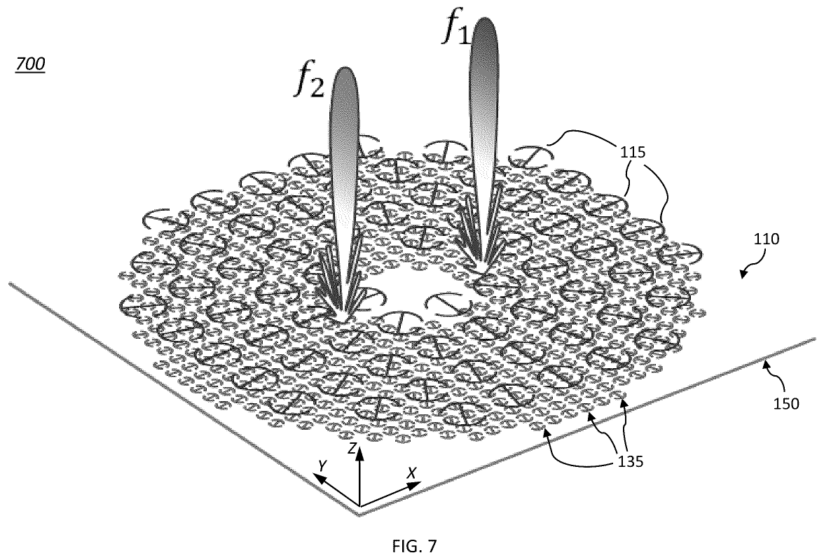

An appendix (“Appendix”) is included at the end of the present specification. The Appendix forms an integral part of the present application and includes, by way of text and figures, further details on the principle of operation of the present multi-band and multi-layer metasurface antenna. Such further details include, for example, further details with respect to FIG. 2, FIG. 4, FIG. 5 and FIG. 7 of the present application, respectively reproduced as FIG. 1, FIG. 2, FIG. 3 and FIG. 6 in the Appendix section of the present disclosure. All references listed at the end of the Appendix are incorporated by reference herein in their entirety.

Metasurface antennas, such as the prior art metasurface antenna (100) of FIG. 1, have raised a great deal of interest in recent years. Key features they offer include lightweight, ultra-thin form factor, polarization control, and a simple feeding mechanism embedded in a radiating aperture/surface of the metasurface antenna. At microwave and millimeter-waves, metasurface antennas (e.g., 100 of FIG. 1) are typically realized with a metal layer (e.g., 110 of FIG. 1) of subwavelength metallic patches (e.g., 115 of FIG. 1, dimensions smaller than ½ λ) arranged on top of a grounded dielectric slab (e.g., a dielectric layer 120 overlying a metal ground layer 150 of FIG. 1). In a simplest implementation, the feed structure (e.g., 180 of FIG. 1) may include a vertical monopole (e.g., inner conductor 184, feeder extension 186 of FIG. 1) placed inside the dielectric slab (e.g., 120 of FIG. 1), for example at the center, or a center region, of the antenna, and coaxially powered (e.g., outer conductor 182 of FIG. 1) from the ground layer (e.g., 150 of FIG. 1, ground plane). As used herein, a “metasurface” or a “metasurface layer” may refer to a planar structure (e.g., metal layer 110) of subwavelength metallic patches (e.g., 115) having dimensions smaller than ½λ. Accordingly, the metal layer (110) by virtue of including subwavelength patches (115) may be referred herein as a metasurface or metasurface layer of the metasurface antenna (100).

FIG. 1 shows a prior art metasurface antenna (100) that includes a (planar) layered structure, including a dielectric layer (120, slab) overlying a ground (metal) layer (150), and a metal layer (110) overlying the dielectric layer (120). The metasurface antenna (100) may be used for transmission and/or reception of electromagnetic waves at a frequency band for which the metasurface antenna (100) is designed for. A radiating aperture (e.g., surface) of the metasurface antenna (100) may be provided by the metal layer (110), with characteristics that may be based on arrangement and shapes/dimensions of metallic patches (115, e.g., structures) formed in the metal layer (100) and interaction of such metallic patches with the dielectric layer (120, e.g., height h and relative permittivity εᵣ of 120). As shown FIG. 1, the metasurface antenna (100) may be referenced within an (x, y, z) coordinate space where the planar profile of the constituent layers (e.g., 110, 120, 150) may be according to the (x, y) plane.

Radiative behavior of the metasurface antenna (100) shown in FIG. 1 is based on excitation of a surface (electromagnetic) wave. The excitation excites an electromagnetic wave such that a power of the electromagnetic wave couples to the metallic patches (115) and the energy provided by the electric and magnetic components of the electromagnetic wave is carried across the metallic patches (115, e.g., in the x, y plane) as the energy leaks up and radiates (e.g., in the z-direction). It should be noted that the dielectric slab (120) surrounding a metallic patch (115) may be considered part of a unit cell when studying the dispersion characteristics that determines an impedance of the (individual) unit cell.

The unit cells of the metasurface antenna (e.g., 100 of FIG. 1) may be represented (e.g., labelled as a) in FIG. 2 as being arranged according to a periodic pattern along the x-direction. As shown in FIG. 2, (centers of) two adjacent unit cells (a) may be arranged at a fixed distance, a, wherein the distance, a, further represents the length of a unit cell (a) along the x-direction. The center of the unit cell (a) may coincide with a center of a corresponding metallic patch (115). It should be noted that the unit cells (a) are subwavelength and non-resonant with the frequency of operation of the metasurface antenna (e.g., 100 of FIG. 1). In other words, a size of the unit cell (a) in either direction is smaller than ½ λ, where λ represents the wavelength corresponding to a frequency of operation of the metasurface antenna. An exemplary size of the unit cell (a) may be in a range from ⅙ λ to ¼ λ. Because the unit cells (a) are subwavelength and non-resonant, the electromagnetic wave may see the metallic patches (115) as a sheet reactance (i.e., surface reactance, surface impedance, represented in FIG. 2 by X_{S}) instead of their individual impedance values, and the electromagnetic wave interacts with the sheet reactance, X_{S}.

With further reference to FIG. 2, because each individual unit cell (a) is subwavelength and non-resonant, then the unit cell (a) can be considered as not including any designed radiative property if excited alone. Instead, a radiative property of the unit cells (a) for provision of a target radiating aperture (e.g., defining polarization, shape and direction of a beam) may be provided by a modulation period (represented in FIG. 2 by a length d, e.g., spatial periodicity) of the unit cells (a), wherein respective sizes/geometries (e.g., length along x-direction) of the metallic patches (115) of the unit cells (a) are modulated over the (local) modulation period, d. According to some embodiments, magnitude/index/depth (e.g., amount of length variation of a metallic patch along the x-direction) and period (e.g., d) of the modulation may be designed to provide, in combination with the size (e.g., a) of the unit cell and the height/thickness and permittivity (denoted h and εᵣ in FIG. 2) of the dielectric layer (120), a specific (e.g., sinusoidal) surface impedance (e.g., X_{S} of FIG. 2) profile based on the target radiating aperture at the frequency of operation of the metasurface antenna (e.g., 100 of FIG. 1). In other words, the sheet reactance, X_{S}, of FIG. 2 may be realized by discretizing the (continuous) surface impedance (e.g., at layer 110) of the metasurface antenna (e.g., 100 of FIG. 1) with the metallic patches (115) of the subwavelength unit cells (a) that smoothly/gradually vary (e.g., in size/geometry) along the surface (e.g., layer 110). Further details related to the realization/generation of the surface impedance (profile) of the metasurface antenna, including mapping of unit cells (a) and corresponding metallic patches (115) into an equivalent (surface) reactance, X_{P}, obtained from a local transmission line model, can be found in the below Appendix section of the present disclosure with particular reference to FIG. 1 of the Appendix.

Teachings according to the present disclosure further expand the above-described techniques for realizing the surface impedance of a (single) metasurface antenna in order to realize a multi-band metasurface antenna that includes a plurality (e.g., 2, 3, 4 or higher) of stacked metasurfaces (e.g., metal layers) having respective surface impedances, wherein the plurality of stacked metasurfaces are configured to provide (simultaneous) operation of the multi-band metasurface antenna according to a plurality of different and largely separate/distant frequencies (e.g., frequency bands).

According to an embodiment of the present disclosure, each metasurface of the plurality of stacked metasurfaces is configured for operation (e.g., provision of a respective surface impedance) at a respective frequency of the plurality of different and largely separate/distant frequencies. According to an embodiment of the present disclosure, metasurfaces of the plurality of stacked metasurfaces are arranged/stacked according to the respective frequencies of operation, wherein the metasurface that operates at the higher frequency is arranged at the bottom of the stack and closer to the bottom ground layer, and wherein the metasurface that operates at the lower frequency is arranged at the top of the stack and farther from the bottom ground layer. According to an embodiment of the present disclosure, the operating frequency of a metasurface is in range from about 200% to 300% or more the operating frequency of a metasurface that is immediately above said metasurface (and therefore farther from the bottom ground layer).

According to an embodiment of the present disclosure, each metasurface of the plurality of stacked metasurfaces is separated from another metasurface via a dielectric layer. According to an embodiment of the present disclosure, the multi-band metasurface antenna comprises a plurality of dielectric layers configured to separate the plurality of stacked metasurfaces from one another. According to an embodiment of the present disclosure, the permittivity of any dielectric layer of the plurality of dielectric layers is equal to the permittivity of any other dielectric layer of the plurality of dielectric layers. According to an embodiment of the present disclosure, the plurality of dielectric layers each have equal permittivity.

According to an embodiment of the present disclosure, operation of each metasurface of the plurality of stacked metasurfaces is independent from, or transparent to, operation of any other metasurface of the plurality of metasurfaces. According to an embodiment of the present disclosure, operation of any metasurface of the plurality of stacked metasurfaces may not influence operation of any other metasurface of the plurality of stacked metasurfaces. According to an embodiment of the present disclosure, a surface impedance (profile) of any metasurface of the plurality of stacked metasurfaces at a frequency of operation of another/different metasurface of the plurality of stacked metasurfaces is a high impedance (e.g., open circuit, quasi-open circuit). In other words, the surface impedance (profile) of any metasurface of the plurality of stacked metasurfaces at a respective frequency of operation of another/different metasurface of the plurality of stacked metasurfaces is orders of magnitude higher than the surface impedance of the another/different metasurface at the respective frequency of operation.

Because the plurality of stacked metasurfaces are independent from one another, there is no requirement for specific alignment between the metasurfaces (e.g., of the respective metallic patches). In turn, this may allow for independent design of the respective surface impedance profiles and therefore radiation behavior of each of the metasurfaces. This is in contrast to some prior art designs wherein multi-band support is provided by taking into account cross coupling (impedance) effects of the stacked metasurfaces in the design, therefore limiting flexibility in design and ultimately performance of the multi-band antenna (e.g., limited separation of the bands frequencies, limited relative sizes of the metallic patches of different metasurfaces, etc.). It should be noted that in contrast to the multi-band metasurface antenna according to the present teachings, because performance (e.g., radiative behavior) of each metasurface of such prior art designs is codesigned with other metasurfaces present in the stack, removing any one of the metasurfaces from the stack may render the multi-band antenna, including any of the remaining metasurfaces, inoperable for its intended use. In other words, the individual metasurfaces (e.g., metasurface antennas) may be designed independently and may be operated independently. As described in detail in the below Appendix section of the present disclosure, validating a high impedance of a metasurface at a frequency of operation of a different metasurface may be provided by imposing a surface wave number associated to the different metasurface on the metasurface being validated. This is to ensure that each (metasurface) layer of the present multi-band metasurface antenna may operate as a single layer or combined with one or more additional layers. Whether single-layer or multi-layer (e.g., dual-layer), the resulting behavior of the antenna will be substantially identical.

According to an embodiment of the present disclosure, the multi-band metasurface antenna includes a plurality of feed structures coupled to respective metasurfaces of the plurality of metasurfaces. According to an embodiment of the present disclosure, each feed structure may include a vertical monopole that traverses through the (dielectric and/or metal) layers of the antenna to couple to the respective metasurface, the vertical monopole coaxially powered from the bottom ground layer. According to an embodiment of the present disclosure, coupling of the vertical monopole to the respective metasurface may be provided at a central region of the respective metasurface. According to an embodiment of the present disclosure, respective vertical monopoles of the plurality of feed structures may be arranged about a center region of the multi-band metasurface antenna and at an offset from one another. It should be noted that such integrated feed structures according to the present teachings may be considered advantageous over externally erected (and therefore bulky) feed structures used in reflectarray and transmitarray antennas for coupling to respective focal points that are away from the antennas.

FIG. 3A shows a simplified cross-sectional view of a multi-layer metasurface antenna (300) according to an embodiment of the present disclosure for operation according to two distant (largely separated) frequency bands (e.g., centered at respective frequencies f₁ and f₂) via respective metasurfaces (110, 115) and (130, 135). In other words, the multi-layer metasurface antenna (300) may be considered a dual-band metasurface antenna (300) having a first metasurface (110, 115) that is configured for operation at a first frequency f₁ and a second metasurface (130, 135) that is configured for operation at a second frequency f₂. According to an embodiment of the present disclosure the dual-band metasurface antenna (300) may be configured for operation according to largely separated frequency bands (i.e., f₂>>f₁), such as, for example, Ka-band (e.g., f₁=27-40 GHz) as a first frequency band, and W-band (e.g., f₂=75-110 GHz) as a second frequency band. According to a nonlimiting embodiment of the present disclosure, the first frequency f₁ may be equal to 35.00 GHz+/−5.00 GHz and the second frequency f₂ may be equal to 94.00 GHz+/−5.00 GHz. According to a nonlimiting embodiment of the present disclosure, the first frequency f₁ may be equal to 35.75 GHz and the second frequency f₂ may be equal to 94.05 GHz.

The dual-band metasurface antenna (300) of FIG. 3A may include a (planar) layered structure (110, 120, 130, 140, 150), including a top (first) metal layer (110), a first dielectric layer (120, slab), a buried/embedded (second) metal layer (130), a second dielectric layer (140) and a (bottom) ground (metal) layer (150). As shown in FIG. 3A, the second dielectric layer (140) overlies and is in contact with (a surface of) the ground metal layer (150): the second metal layer (130) overlies and is in contact with (a surface of) the second dielectric layer (140); the first dielectric layer (120) overlies and is in contact with (a surface of) the second metal layer (130); and the first metal layer (110) overlies and is in contact with (a surface of) the first dielectric layer (120).

It should be noted that teachings according to the present disclosure may be used to realize any stacked sequence of interleaved dielectric (e.g., 120, 140) and metal (e.g., 110, 130) layers arranged atop a ground layer (e.g., 150) similar to one showed in FIG. 3A, including a stacked sequence that includes more than two metal layers interleaved with two dielectric layers for provision of a multi-band metasurface antenna that supports more than two bands. In other words, the exemplary dual-band metasurface antenna (e.g., 300 of FIG. 3A) described herein may not be considered as limiting the scope the present disclosure.

Furthermore, it should be noted that methods and techniques used to fabricate a stacked layer configuration, such as one shown in FIG. 3A, are well known in the art and outside the scope of the present disclosure. Such fabrication methods and techniques may include, for example, for each of the metasurfaces, forming of corresponding metal structures, (110, 115) and (130, 135), on a dielectric slab/substrate/layer, 120 and 140, of appropriate height/thickness, (h₁−h₂) and h₂, to produce a respective combined dielectric/metasurface structure, and bonding the respective combined dielectric/metasurface structures to form the stacked layer configuration.

Furthermore, it should be noted that the metallic patches (e.g., 115, 135) formed in the respective metasurfaces (110, 115) and (130, 135) of the dual-band metasurface antenna (300) of FIG. 3A may include any shape/geometry, including, for example, rectangular/square, triangle, circle, pentagon, octagon, hexagon, cross, etc., or any combination thereof. Furthermore, such shape/geometry may include one or more axes of symmetry. In general, teachings according to the present disclosure are compatible with any metasurface known in the art that is capable of manipulating the phase, amplitude, and polarization of electromagnetic waves, thereby enabling radiation control (e.g., beamforming and focusing capabilities) of a single layer metasurface antenna (e.g., 100 of FIG. 1).

With continued reference to FIG. 3A, the each of the metal layers (110, 130, e.g., metasurfaces) may include respective subwavelength metallic patches (115, 135) for provision of respective radiative apertures. In other words, the respective metallic patches (115, 135) of the metal layers (110, 130) are configured to provide radiation control at a respective frequency f₁ or f₂. Because the dielectric layers (120, 140) have a same permittivity (e.g., εᵣ), the dual-band metasurface antenna (300) may be considered as including: a (combined) dielectric layer/slab (120+140) overlying the ground layer (150); a first metasurface layer (110, 115) overlying the dielectric layer/slab (120+140), and therefore arranged at a distance h₁ from the ground layer (150); and a second metasurface layer (130, 135) embedded/buried within the dielectric layer/slab (120+140) and arranged at a distance h₂ from the ground layer (150). It should be noted that the heights/thicknesses h₁ and h₂ may be considered parameters for the design of the respective metasurfaces. In some designs, a ratio of h₂ over h₁ may be in a range from 0.25 to 0.75.

Because the metasurfaces (110, 115) and (130, 135) are independent in operation from one another, then as shown in the top region of FIG. 3B, at the first frequency of operation, f₁, the dual-band metasurface antenna (300) may be likened to a single band metasurface antenna that includes a (first) metasurface (110, 115) overlying a dielectric layer/slab (120+140) having a thickness, h₁, the dielectric layer/slab (120+140) overlying the ground layer (150). In other words, and as shown in the top region of FIG. 3B, at the first frequency of operation, f₁, the (second) metasurface (130, 135) is transparent (and therefore not shown) to the operation of the first metasurface (110, 115). As described above in the present disclosure, such transparency is due to the high impedance presented by the second metasurface (130, 135) at the first frequency of operation, f₁.

On the other hand, as shown in bottom region of FIG. 3B, at the second frequency of operation, f₂, the dual-band metasurface antenna (300) may be likened to a single band metasurface antenna that includes the second metasurface (130, 135) embedded/buried in the dielectric layer/slab (120+140) at a distance, h₂, from the ground layer (150). In other words, and as shown in the bottom region of FIG. 3B, at the second frequency of operation, f₂, the first metasurface (110, 115) is transparent (and therefore not shown) to the operation of the second metasurface (130, 135). As described above in the present disclosure, such transparency is due to the high impedance presented by the first metasurface (110, 115) at the second frequency of operation, f₂.

Based on the above, and as previously described in the present disclosure, the mutually transparent first (110, 115) and second (130, 135) metasurfaces may allow simultaneous operation of the of the dual-band metasurface antenna (300) according to two separate and distant frequencies, f₁ and f₂, wherein operation (e.g., radiative behavior) at each of the frequencies may be provided by a corresponding design of a single layer metasurface antenna shown in the top and bottom regions of FIG. 3B.

FIG. 4 shows respective features of the two metasurface layers (110, 115) and (130, 135) used for generation of respective surface impedance profiles (e.g., X_{S1}, X_{S2}) of the dual-band metasurface antenna (300) according to an embodiment of the present disclosure. Such features may be readily understood from the above description related to FIG. 2 wherein subscripts 1 and 2 are used to indicate respective features corresponding to operation at the first and second frequencies, f₁ and f₂. Further details can be found in the below Appendix section of the present disclosure with particular reference to FIG. 2 of the Appendix.

As explained in detail in the below Appendix section of the present disclosure, the sheet reactance (e.g., X_{S1}, X_{S2}) provided by the periodic array of metallic patches (e.g., 115 or 135 of FIG. 4 with a period d₁ or d₂) is purely imaginary and exhibits a capacitive behavior in the low frequency regime. As a result, according to the Foster's reactance theorem, its frequency response presents a pole at zero frequency and then it increases monotonically with alternating zeros and poles for increasing frequencies. Teachings according to the present disclosure exploit properties dictated by the Foster's reactance theorem to make the first metasurface layer (110, 115) working at the first frequency, f₁, transparent at the second frequency, f₂, and the second metasurface layer (130, 135) working at the second frequency, f₂, transparent at the first frequency, f₁.

As shown in FIG. 4, each of the two reactance sheets (e.g., X_{S1}, X_{S2}) shown in FIG. 4, can be implemented by gradually changing (e.g., modulating) the size and geometry of the respective subwavelength patches, 115 and 135, over the respective periods, dᵢ and d₂. Furthermore, as described in detail in the below Appendix section of the present disclosure with particular reference to FIG. 2 of the Appendix, the patches (e.g., 115, 135) are linked to an equivalent (surface) impedance (e.g., X_{P1}, X_{P2}) extracted from an equivalent transmission line model based on the local periodicity approximation (e.g., over the respective spatial periodicity d₁ and d₂). This model can be defined for each of the two reactance sheets, X_{S1} and X_{S2}, with X_{P1} and X_{P2} representing the equivalent reactance of the patches, (115) and (135), in the respective locally periodic environment. It should be noted that the equivalent reactance, X_{P1} or X_{P2}, may be considered as equivalent surface reactance of the entire surface of a corresponding metasurface (e.g., 110, 115 or 130, 135). It should be noted that derivation of the equivalent (surface) reactance, X_{P2}, may take into account the embedding of the second metasurface (130, 135) inside the dielectric (e.g., 120+140, e.g., via the Green's function is adjusted to account for the impedance being internal to the dielectric). Furthermore, as shown in details (b) and (d) of FIG. 4, the metasurface (130, 135) may be designed assuming no impedance layers (e.g., layer 110, 125) on a top surface of the dielectric (e.g., 120+140).

According to an embodiment of the present disclosure, and as shown in FIG. 5, the equivalent impedance (i.e., reactance, X_{P1}) of each unit cell (al) of the first metasurface layer (110, 115, e.g., metallic layer) operating at the first frequency, f₁, is selected (or verified) to be at, or close to (e.g., near to, at a vicinity of, etc.), a pole at the second frequency, f₁, thereby presenting a high impedance at the second frequency, f₂. Likewise, the equivalent impedance (i.e., reactance, X_{P2}) of the second metasurface layer (130, 135, e.g., metallic layer) operating at the second frequency, f₂, is selected (or verified) to be at, or close to, a pole at the first frequency, f₁, thereby presenting a high impedance at the first frequency, f₁. In particular, as shown in the left graph of FIG. 5, at the first frequency, f₁, the equivalent reactance, X_{P2}, is shown as a quasi-open circuit, and therefore must be close to a respective pole. Likewise, as shown in the right graph of FIG. 5, at the second frequency, f₂, the equivalent reactance, X_{P1}, is shown as a quasi-open circuit (close to a resonance), and therefore must be close to a respective pole.

As described in detail in the below Appendix section of the present disclosure, including with reference to FIGS. 2-3 of the Appendix, a separation between the two frequencies, f₁ and f₂, which therefore establishes relative sizes of the metallic patches (115, 135), may also establish possible positions of the respective poles for operation of each of the equivalent reactance, X_{P1} and X_{P2}, according to a high impedance. According to an embodiment of the present disclosure, such poles may include: a pole at a zero frequency for operation of the equivalent reactance, X_{P2}, at the first frequency, f₁, and a pole at a higher frequency, and therefore different from a corresponding pole at the zero frequency, for operation of the equivalent reactance, X_{P1}, at the second frequency, f₂. As described in detail in the below Appendix section of the present disclosure, metasurface layers of the multi-band metasurface antenna according to the present teachings are initially designed and the placement of the respective impedances and the poles are checked. To adjust the these, the respective surface reactance can be adapted to have a different average impedance or a slightly different frequency. The unit cell can also be adapted to account for new values of the surface impedance.

FIG. 6 shows a feed structure (680₁, 680₂) according to an embodiment of the present disclosure integrated/embedded within the dual-band metasurface antenna (300). As shown in FIG. 6, such feed structure may include a first feed structure (680₁) coupled to the first metasurface layer (110, 115) and a second feed structure (680₂) coupled to the second metasurface layer (130, 135), the first and second feed structures, (680₁) and (680₂), arranged at an offset from one another. As shown in FIG. 6, each of the first (680₁) and second (680₂) feed structures may include elements (682, 684, 686) that may be equivalent to elements (182, 184, 186) of the feed structure (180) described above with reference to FIG. 1. In particular, such elements may include a vertical monopole (e.g., inner conductor 684, feeder extension 686) placed inside the dielectric slabs (e.g., 120 and/or 140), for example at a center region of the antenna (300), and coaxially powered (e.g., outer conductor 682) from the ground layer (150, ground plane).

As shown in FIG. 6, the feeder extension (686) may be a planar structure that is in contact (e.g., and coplanar) with a respective metasurface layer (e.g., 110, 115 or 130, 135), and the inner conductor (684) may be vertically routed through layers (e.g., 110, 120, . . . , 150) of the dual-band metasurface antenna (300) to make contact to a respective feeder extension (686). Accordingly, the inner conductor (684) associated to the metasurface (110, 115) may traverse the layers (150, 140, 130, 120) to contact the respective feeder extension (686). On the other hand, the inner conductor (684) associated to the metasurface (130, 135) may traverse the layers (150, 140) to contact the respective feeder extension (686).

FIG. 7 shows a top view of a multi-layer metasurface antenna (700) according to an exemplary embodiment of the present disclosure. Design of such antenna may be based on the above description related to FIGS. 3-6. In particular, the antenna (700) shown in FIG. 7 may be an exemplary implementation of the dual-band metasurface antenna (300) operating at the first and second frequencies, f₁ and f₂, as described above with reference to FIG. 3A. Outlines of the totality of the first and second patches (115, 135) may define the respective first and second metasurface layers that according to FIG. 7 may be of a substantially same size. According to an exemplary nonlimiting embodiment of the present disclosure, the antenna (700) may have a radius that is equal to 3λ at the first frequency of operation, f₁, and equal to 5λ at the second frequency of operation, f₂. It should be noted that teaching according to the present disclosure may not impose any relative size, alignment, or outlines of the used metasurface layers.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The references in the present application are incorporated herein by reference in their entirety. All references listed in the Appendix are incorporated by reference herein in their entirety.

### APPENDIX

1. A dual-band metasurface antenna, comprising:
a ground layer;
a dielectric layer overlying the ground layer:
a first metasurface layer configured for operation at a first frequency, the first metasurface layer overlying the dielectric layer; and
a second metasurface layer configured for operation at a second frequency that is higher than the first frequency, the second metasurface layer embedded within the dielectric layer,
wherein
at the first frequency of operation, the second metasurface layer presents a high impedance, and
at the second frequency of operation, the first metasurface layer presents a high impedance.

2. The dual-band metasurface antenna of claim 1, wherein:
the second frequency is in a range from 200% to 300% the first frequency.

3. The dual-band metasurface antenna of claim 1, wherein:
the first frequency is in a range from 27 GHz to 40 GHz, and
the second frequency is in a range from 75 GHz to 110 GHz.

4. The dual-band metasurface antenna of claim 1, further comprising:
an integrated feed structure comprising first and second monopoles vertically routed through the ground layer and the dielectric layer to respectively make contact with the first and second metasurface layers.

5. The dual-band metasurface antenna of claim 4, wherein,
each monopole of the first and second monopoles includes:
a feeder extension that is in contact with the respective metasurface layer; and
an inner inductor that is vertically routed through the ground layer and the dielectric layer to make contact with the feeder extension.

6. The dual-band metasurface antenna of claim 1, wherein,
each metasurface layer of the first and the second metasurface layers comprises:
a plurality of subwavelength unit cells, each unit cell of the plurality of subwavelength unit cells comprising a metallic patch with subwavelength dimensions.

7. The dual-band metasurface antenna of claim 6, wherein,
each unit cell of the plurality of subwavelength unit cells is non-resonant at the first and second frequencies.

8. The dual-band metasurface antenna of claim 6, wherein,
centers of unit cells of the plurality of subwavelength unit cells are arranged at a fixed distance from one another.

9. The dual-band metasurface antenna of claim 6, wherein,
a sequence of unit cells of the plurality of subwavelength unit cells includes a periodic pattern provided by modulation of a dimension of respective metallic patches along one direction.

10. The dual-band metasurface antenna of claim 9, wherein,
the periodic pattern is configured to provide a radiation behavior of the each metasurface layer at a respective frequency of the first or second frequency.

11. The dual-band metasurface antenna of claim 9, wherein,
the periodic pattern is configured to provide a surface impedance of the each metasurface layer at a respective frequency of the first or second frequency, and
the surface impedance at the other frequency of the first or second frequency is a high impedance.

12. The dual-band metasurface antenna of claim 9, wherein,
the periodic pattern is configured to provide a local periodicity of a surface impedance of the each metasurface layer at a respective frequency of the first or second frequency, and
an equivalent impedance of the surface impedance is derived from an equivalent transmission line model based on the local periodicity of the surface impedance.

13. The dual-band metasurface antenna of claim 12, wherein,
the equivalent impedance is an equivalent reactance,
a frequency response of the equivalent reactance includes a pole at zero frequency followed by alternating zeros and poles for increasing frequencies, and
the equivalent reactance at the other frequency of the first or second frequency is at a vicinity of a pole of the frequency response.

14. The dual-band metasurface antenna of claim 1, wherein,
the dielectric layer is provided by bonding a first dielectric slab to a second dielectric slab of equal permittivity,
the first metasurface layer overlying the first dielectric slab, and the second metasurface layer overlying the second dielectric slab.

15. A multi-band metasurface antenna, comprising:
a ground layer;
a dielectric layer overlying the ground layer;
a top metasurface layer overlying the dielectric layer; and
a plurality of embedded metasurface layers embedded within the dielectric layer,
wherein
each metasurface layer of the top metasurface layer and the plurality of embedded metasurface layers is configured for operation at a respective frequency of a plurality of different frequencies,
the respective frequency of a metasurface layer of the plurality of embedded metasurface layers arranged at a respective distance from the ground layer is higher than the respective frequency of any metasurface layer of the top metasurface layer or the plurality of embedded metasurface layers arranged at a farther respective distance from the ground layer, and
a respective impedance of a metasurface layer of the top metasurface layer or the plurality of embedded metasurface layers at a frequency of the plurality of different frequencies that is different from the respective frequency is a high impedance.

16. The multi-band metasurface antenna of claim 15, further comprising:
an integrated feed structure comprising a plurality of monopoles, each monopole of the plurality of monopoles vertically routed through the ground layer and the dielectric layer to make contact with a respective metasurface layer of the top metasurface layer or the plurality of embedded metasurface layers.

17. The multi-band metasurface antenna of claim 15, wherein,
each metasurface layer of the top metasurface layer and the plurality of embedded metasurface layers comprises a plurality of subwavelength unit cells, each unit cell of the plurality of subwavelength unit cells comprising a metallic patch with subwavelength dimensions.

18. The multi-band metasurface antenna of claim 17, wherein,
a sequence of unit cells of the plurality of subwavelength unit cells includes a periodic pattern provided by modulation of a dimension of respective metallic patches along one direction.
the periodic pattern is configured to provide a local periodicity of a surface impedance of the each metasurface layer at the respective frequency,
an equivalent reactance of the surface impedance is derived from an equivalent transmission line model based on the local periodicity of the surface impedance,
a frequency response of the equivalent reactance includes a pole at zero frequency followed by alternating zeros and poles for increasing frequencies, and
the equivalent reactance at the frequency of the plurality of different frequencies that is different from the respective frequency is at a vicinity of a pole of the frequency response.

19. A method for realizing a dual-band metasurface antenna, the method comprising:
realizing a first metasurface for operation at a first frequency by forming a first sequence of a plurality of first subwavelength unit cells having a first periodic pattern provided by modulation of a dimension of respective first metallic patches, thereby providing a local periodicity of a first surface impedance of the first metasurface at the first frequency; and
realizing a second metasurface for operation at a second frequency by forming a second sequence of a plurality of second subwavelength unit cells having a second periodic pattern provided by modulation of a dimension of respective second metallic patches, thereby providing a local periodicity of a second surface impedance of the second metasurface at the second frequency,
wherein the realizing of the first metasurface further includes:
based on the local periodicity of the first surface impedance, deriving an equivalent first reactance of the first surface impedance from a transmission line model, the equivalent first reactance provided by a first frequency response that includes a pole at zero frequency followed by alternating zeros and poles for increasing frequencies; and
making or verifying that the equivalent first reactance at the second frequency is near to, or at, a pole of the first frequency response, thereby making the first surface impedance high at the second frequency.

20. The method according to claim 19,
wherein the realizing of the second metasurface further includes:
based on the local periodicity of the second surface impedance, deriving an equivalent second reactance of the second surface impedance from a transmission line model, the equivalent second reactance provided by a second frequency response that includes a pole at zero frequency followed by alternating zeros and poles for increasing frequencies; and
making or verifying that the equivalent second reactance at the first frequency is near to, or at, a pole of the second frequency response, thereby making the second surface impedance high at the first frequency.
